(19) United States
(12) Patent Application Publication
(10) Pub. No.: US 2023/0061522 A1
(43) Pub. Date: Mar. 2, 2023

(54) CONCEPT FOR MONITORING A DATA FUSION FUNCTION OF AN INFRASTRUCTURE SYSTEM

(71) Applicant: Robert Bosch GmbH, Stuttgart (DE)

(72) Inventors: Adwait Sanjay Kale, Ludwigsburg (DE); Nils Uhlemann, Ludwigsburg (DE); Alexander Geraldy, Hildesheim (DE); Holger Mindt, Steinheim A. D. Murr (DE)

(21) Appl. No.: 17/896,229

(22) Filed: Aug. 26, 2022

(30) Foreign Application Priority Data
Sep. 2, 2021 (DE) 10 2021 209 670.0

(51) Int. Cl. G08G 1/0967; B60W 50/00

(52) U.S. Cl. CPC G08G 1/096783; B60W 50/0098; G08G 1/096708; B60W 2556/35; B60W 2554/4044; B60W 2554/4041

(57) ABSTRACT

A method for monitoring a data fusion function of an infrastructure system for the infrastructure-supported assistance of motor vehicles during an at least semi-automated driving task within an infrastructure, the infrastructure including multiple infrastructure surroundings sensors for detecting an area of the infrastructure. The method includes: receiving multiple input data sets intended for the data fusion function, each of which includes surroundings data based on the respective detection of the area, which represent the detected area; receiving output data based on a data fusion of the input data sets, output by the data fusion function; checking the input data sets and/or the output data for consistency; outputting a check result of the check. A device, a computer program, and a machine-readable memory medium are also provided.

### FIELD

The present invention relates to a method for monitoring a data fusion function of an infrastructure system for the infrastructure-supported assistance of motor vehicles during an at least semi-automated vehicle task within an infrastructure, to a device, to a computer program and to a machine-readable memory medium.

### BACKGROUND INFORMATION

German Patent Application No. DE 10 2016 224 074 A1 describes a device for operating a vehicle.

German Patent Application No. DE 10 2015 226 116 A1 describes a method for assessing a hazardous situation detected by at least one sensor of a vehicle.

### SUMMARY

An object of the present invention is to provide efficient monitoring of a data fusion function of an infrastructure system for the infrastructure-supported assistance of motor vehicles during an at least semi-automated driving task within an infrastructure.

This object may be achieved with the aid of the respective subject matter of the present invention. Advantageous embodiments of the present invention are disclosed herein.

According to one first aspect of the present invention, a method is provided for monitoring a data fusion function of an infrastructure system for the infrastructure-supported assistance of motor vehicles during an at least semi-automated driving task within an infrastructure, the infrastructure system including multiple infrastructure surroundings sensors for detecting an area of the infrastructure. According to an example embodiment of the present invention, the method includes the following steps:

receiving multiple input data sets intended for the data fusion function, each of which includes surroundings data based on the respective detection of the area, which represent the detected area,

receiving output data based on a data fusion of the input data sets, output by the data fusion function, checking the input data sets and/or the output data sets for consistency,

outputting a check result of the check.

According to one second aspect of the present invention, a device is provided, which is configured to carry out all steps of the method according to the first aspect of the present invention.

According to one third aspect of the present invention, a computer program is provided, which includes commands which, when the computer program is executed by a computer, for example, by the device according to the second aspect, prompt the computer to carry out the method according to the first aspect of the present invention.

According to one fourth aspect of the present invention, a machine-readable memory medium is provided, on which the computer program according to the third aspect is stored.

According to an example embodiment of the present invention the above object may be achieved by checking the input data sets and/or the output data sets of a data fusion function for consistency. This yields, for example, the technical advantage that the data fusion function of the infrastructure system is able to be efficiently monitored.

The data fusion function of the infrastructure system thus merges pieces of information from multiple infrastructure surroundings sensors in order to support or assist motor vehicles, based on a corresponding data fusion result, during an at least semi-automated driving task within the infrastructure. This yields, for example, the technical advantage that the motor vehicles are able to be efficiently driven in an at least semi-automated manner within the infrastructure, since the motor vehicles obtain as a result of the support, for example, pieces of information about areas of the infrastructure, which could be detected only partially or not at all by on-board surroundings sensors.

In order for vehicles to be able to rely on pieces of information during their drive within the infrastructure driven in at least a semi-automated manner, i.e., on pieces of information that have been ascertained based on the output data of the data fusion function, it is advantageous that the output data, which specify or include, in particular, a fusion result of the fused input data sets, are safe and as good as or better than on-board motor vehicle sensors, without hereby including any disadvantages or limitations.

By now checking the input data set and/or the output data of the data fusion function for consistency, it is possible to efficiently contribute to the fulfillment of the above-mentioned requirements. As a result, the motor vehicle is able, for example, advantageously, to safely execute or carry out its at least semi-automated driving task.

Thus, this further yields the technical advantage that during an at least semi-automated driving task within an infrastructure, a motor vehicle is able to be efficiently supported or assisted in an infrastructure-supported manner.

In the data fusion function, the input data sets are fused in order to ascertain one or multiple fusion results. The output data include the ascertained fusion result or results.

The wording that the input data sets are intended for the data fusion function means that the input datasets are intended directly for the data fusion function, so that the data fusion function uses these directly for a data fusion.

The infrastructure surroundings sensors are, for example, situated in a spatially distributed manner within the infrastructure.

An infrastructure surroundings sensor is, for example, one of the following surroundings sensors: radar sensor, LIDAR sensor, video sensor, ultrasonic sensor, magnetic field sensor and infrared sensor.

According to one specific example embodiment of the present invention, it is provided that some of the input data sets include in each case an open space recognition result, which indicates a result of an open space recognition of the area, the output data including a fused open space recognition result of the respective open space recognition results.

This yields, for example, the technical advantage that the open space recognition results and/or the fused open space recognition result is/are able to be efficiently checked for consistency.

According to one specific example embodiment of the present invention, it is provided that some of the input data sets include in each case an object detection result, which indicates a result of an object detection of the area, the output data including a fused object detection result of the respective object detection results.

This may yield, for example, the technical advantage that the object detection results and/or the fused object detection result is/are able to be efficiently checked for consistency.

According to one specific example embodiment of the present invention, it is provided that the checking includes a comparison of the fused open space recognition result with the fused object detection result in order to detect inconsistencies.

This may yield, for example, the technical advantage that the check is able to be efficiently carried out so that inconsistencies are able to be efficiently detected. If, for example, the fused open space recognition result indicates an open space at one point of the area, but for exactly this point the fused object detection results indicate a detected object, then an inconsistency is present.

In one specific embodiment of the present invention, it is provided that an object detection majority result is ascertained, which corresponds to the object detection result of the majority of identical object detection results, the check including a comparison of the fused object detection result with the object detection majority result in order to detect inconsistencies.

This may yield, for example, the technical advantage that the check is able to be efficiently carried out, so that the fused object detection result is able to be efficiently checked for inconsistencies.

According to one specific example embodiment of the present invention, it is provided that one of the input data sets includes trajectory data, which represent a trajectory of an object located within the area, the check including a check of the trajectory for plausibility in order to detect inconsistencies.

This may yield, for example, the technical advantage that the check is able to be efficiently carried out, so that inconsistencies are able to be efficiently detected. A trajectory of an object located within an area should, for example, extend within boundary markings of a road. If this is not the case, this is, for example, an inconsistency. An object is subject to physical laws. Should the trajectory of the object be physically impossible, an inconsistency is present.

According to one specific example embodiment of the present invention, it is provided that one of the input data sets includes position data, which represent an initial position of an object within the area at a point in time of an initial detection by the corresponding infrastructure surroundings sensor, the check including a comparison of the initial position with a maximum detection range of the corresponding infrastructure surroundings sensor in order to detect inconsistencies between the initial position and the maximum detection range.

This may yield, for example, the technical advantage that the check is able to be efficiently carried out, so that inconsistencies between the initial position and the maximum detection range are able to be efficiently detected. This specific embodiment is based on the idea that under optimal preconditions, an object is initially detected at the maximum detection range of the corresponding infrastructure surroundings sensor. If an initial detection of the object by the corresponding infrastructure surroundings sensor takes place only within the maximum detection range, then an inconsistency is present which, for example, is an indication that deteriorating detection conditions are present, for example, fog, snow, rain and/or a contaminated infrastructure surroundings sensor.

According to one specific example embodiment of the present invention, it is provided that one of the input data sets includes position data, which represent an end position of an object located within the area at a point in time of a final detection by the corresponding infrastructure surroundings sensor, the check including a comparison of the end position with a maximum detection range of the corresponding infrastructure surroundings sensor in order to detect inconsistencies between the end position and the maximum detection range.

This may yield, for example, the technical advantage that the check is able to be efficiently carried out, so that inconsistencies between the end position and the maximum detection range are able to be efficiently detected. This specific embodiment is the counterpart to aforementioned specific embodiments with respect to the initial position, except that here the end position of the final detection of the object is viewed by the corresponding infrastructure surroundings sensor. Should the corresponding end position lie within the maximum detection range, then an inconsistency is present. Under optimal preconditions, the object should always be able to be detected at the maximum detection range by the corresponding infrastructure surroundings sensor. The reasons for a behavior deviating therefrom are the same as those identified above in conjunction with the specific embodiment relating to the initial position.

According to one specific example embodiment of the present invention, the method according to the first aspect is a computer-implemented method.

Technical functionalities of the method result similarly from corresponding technical functionalities of the device and vice versa. This means, therefore, that device features result from corresponding method features and vice versa.

A drive of a motor vehicle within the context of the description is, for example, a drive driven in an at least semi-automated manner, in particular, a drive driven in an infrastructure-supported, at least semi-automated manner.

An at least semi-automated driving task includes, for example, a drive driven in an at least semi-automated manner. The vehicle is therefore driven, for example, in an at least semi-automated manner. An at least semi-automated driving task therefore includes an at least semi-automated driving of the motor vehicle or the motor vehicles.

The wording “at least semi-automated driving” includes one or multiple of the following cases: assisted driving, semi-automated driving, highly automated driving, fully automated driving. The wording “at least semi-automated” therefore includes one or multiple of the following wordings: assisted, semi-automated, highly-automated, fully automated.

Assisted driving means that a driver of the motor vehicle continuously carries out the transverse guidance or the longitudinal guidance of the motor vehicle. The respectively other driving task (i.e. a controlling of the longitudinal guidance or the transverse guidance of the motor vehicle) is carried out automatically. This means, therefore, that during an assisted driving of the motor vehicle either the transverse guidance or the longitudinal guidance is controlled automatically.

Semi-automated driving means that in a specific situation (for example: driving on an expressway, driving within a parking facility, passing an object, driving within a traffic lane, which is defined by traffic lane markings) and/or for a certain period of time, a longitudinal guidance and a transverse guidance of the motor vehicle are controlled automatically. A driver of the motor vehicle him/herself does not have to manually control the longitudinal guidance and transverse guidance of the motor vehicle. However, the driver must continually monitor the automatic control of the longitudinal guidance and transverse guidance in order to be able to manually intervene if needed. The driver must be prepared to take full driving control of the motor vehicle at any time.

Highly automated driving means that for a certain period of time in a specific situation (for example: driving on an expressway, driving within a parking facility, passing an object, driving within a traffic lane defined by traffic lane markings), a longitudinal guidance and a transverse guidance of the motor vehicle are controlled automatically. A driver of the motor vehicle him/herself does not have to manually control the longitudinal guidance and transverse guidance of the motor vehicle. The driver does not have to continually monitor the automatic control of the longitudinal guidance and transverse guidance in order to be able to manually intervene if needed. If needed, a take-over request is automatically output to the driver for taking control of the longitudinal guidance and transverse guidance, in particular, with a sufficient time reserve. The driver must therefore potentially be able to take control of the longitudinal guidance and the transverse guidance. Limits of the automatic control of the transverse guidance and the longitudinal guidance are automatically recognized. During highly-automated driving, it is not possible to automatically bring about a minimal risk state in every initial situation.

Fully automated driving means that in a specific situation (for example: driving on an expressway, driving within a parking facility, passing an object, driving within a traffic lane defined by traffic lane markings), a longitudinal guidance and transverse guidance of the motor vehicle is controlled automatically. A driver of the motor vehicle him/herself does not have to manually control the longitudinal guidance and transverse guidance of the motor vehicle. The driver does not have to monitor the automatic control of the longitudinal guidance and transverse guidance in order to be able to manually intervene if needed. Prior to a termination of the automatic control of the transverse guidance and longitudinal guidance, a request is automatically made to the driver to assume the driving task (control of the transverse guidance and longitudinal guidance of the motor vehicle), in particular, with a sufficient time reserve. If the driver does not assume the driving task, a return to a minimal risk situation takes place automatically. Limits of the automatic control of the transverse guidance and longitudinal guidance are automatically recognized. In all situations, it is possible to return automatically to a minimal risk system state.

In one specific example embodiment of the present invention, it is provided that the method according to the first aspect is carried out with the aid of the device according to the second aspect of the present invention.

The terms “assist” and “support” may be used synonymously.

### BRIEF DESCRIPTION OF THE DRAWINGS

Exemplary embodiments of the present invention are represented in the figures and explained in greater detail below.

FIG. 1 shows a flowchart of a method according to the first aspect of the present invention.

FIG. 2 shows a device according to the second aspect of the present invention.

FIG. 3 shows a machine-readable memory medium according to the fourth aspect of the present invention.

FIG. 4 shows a block diagram according to an example embodiment of the present invention.

FIGS. 5 through 8 each shows a motor vehicle, which is driving on a road.

### DETAILED DESCRIPTION OF EXAMPLE EMBODIMENTS

In the following, identical reference numerals may be used for identical features.

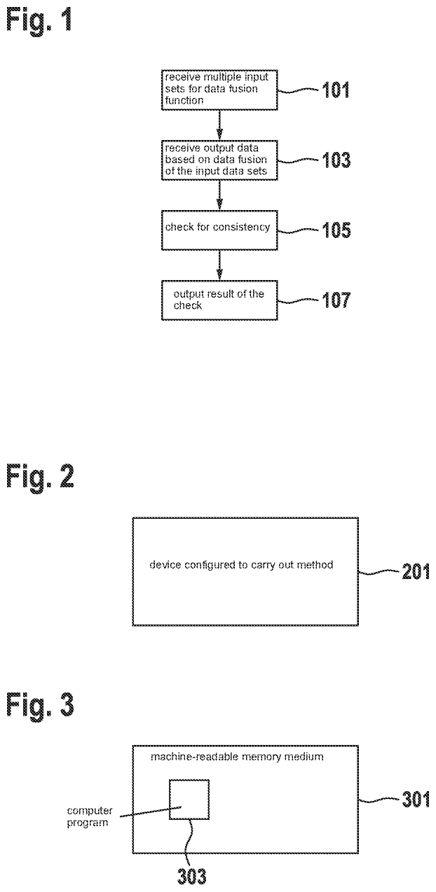

FIG. 1 shows a flowchart of a method for monitoring a data fusion function of an infrastructure system for the infrastructure-supported assistance of motor vehicles during an at least semi-automated driving task within an infrastructure, the infrastructure system including multiple infrastructure surroundings sensors for detecting an area of the infrastructure, including the following steps:

receiving 101 multiple input data sets intended for the data fusion function, each of which includes surroundings data based on the respective detection of the area, which represent the detected area,

receiving 103 output data based on a data fusion of the input data sets, output by the data fusion function, checking 105 the input data sets and/or the output data sets for consistency,

outputting 107 a check result of the check.

According to one specific embodiment, it is decided based on the check result whether the infrastructure system is to be switched off or whether an assistance function provided by the infrastructure system is to be limited.

In one specific embodiment of the method, this includes a step of detecting the area via the multiple infrastructure surroundings sensors in order to output surroundings sensor data corresponding to the detection. The output surroundings sensor data are further processed, for example, in order to ascertain surroundings data based in each case on the respective detection of the area, which represent the detected area.

In one specific embodiment of the method, this includes a fusing of the input data sets in order to ascertain one or multiple fusion results, the output data including the ascertained fusion result or results. Thus, this means, in particular, that the method includes, for example, an implementation of the data fusion function.

FIG. 2 shows a device 201, which is configured to carry out all steps of the method according to the first aspect.

FIG. 3 shows a machine-readable memory medium 301, on which a computer program 303 is stored. Computer program 303 includes commands which, when computer program 303 is executed by a computer, prompt the computer to carry out a method according to the first aspect.

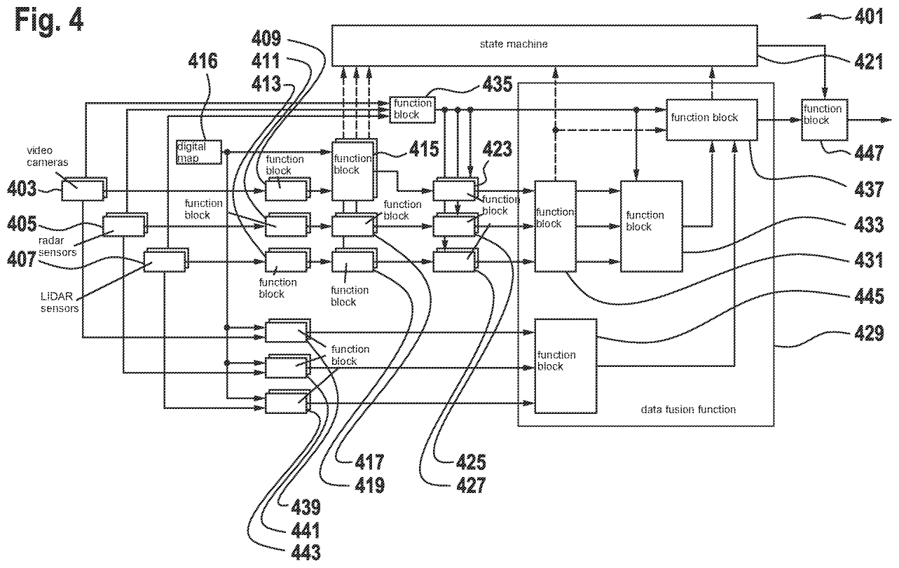

FIG. 4 shows a block diagram 401, which is intended to explain by way of example the concept described herein.

According to block diagram 401, multiple video cameras 403 including one video sensor each are provided. Multiple radar sensors 405 are further provided. Multiple LIDAR sensors 407 are further provided. These infrastructure surroundings sensors detect one or multiple areas of an infrastructure, through which motor vehicles are able to drive in at least a semi-automated manner. The motor vehicles are supported in this case by an infrastructure system for the infrastructure-supported assistance of motor vehicles during an at least semi-automated driving task. Infrastructure surroundings sensors 403, 405, 407 are encompassed by the infrastructure system.

According to one function block 409, an object recognition is carried out based on the video images of video cameras 403. A track detection also takes place within the scope of this object recognition.

According one function block 411, an object recognition is carried out based on the radar images of radar sensors 405.

According to one function block 413, an object detection is carried out based on the LIDAR images of LIDAR sensors 407.

A result of the object detection according to function block 409 is fed to a function block 415, according to which the result is checked. This check includes, for example, a plausibility check. A digital map 416 of the infrastructure is used for the check. Should, for example, digital map 416 shows an object at a point that is not present in the result according to function block 409, then it is assumed, for example, that an error has occurred, for example, within the scope of the object recognition and/or already in one or in multiple of video cameras 403.

Similarly, a result of the object recognition according to function block 411 is fed to a function block 417, according to which, similar to function block 415, the result of the object recognition is checked according to function block 411. The corresponding explanations apply similarly.

Similarly, a result of the object recognition according to function block 413 is fed to a function block 419, according to which, similar to function blocks 415, 417, the result of the object recognition is checked according to function block 413. The corresponding explanations apply similarly.

The results of these checks are conveyed to a state machine 421. Based on these results, state machine 421 is able to ascertain, for example, a state of the operability of the infrastructure system with respect to an infrastructure-supported assistance of motor vehicles. One state may, for example, be that the infrastructure system functions completely correctly. One state may, for example, be that the infrastructure system functions to only a limited degree. One state may, for example, be that the infrastructure system functions completely incorrectly.

The checked result according to function block 415 is fed to a function block 423. This means, therefore, that function block 423 is fed a checked result of the object and track recognition according to function block 409. According to function block 423, detected objects are tracked over time.

Similarly, the result of the object recognition checked by function block 417 according to function block 411 is fed to a function block 425. Function block 425 tracks the detected objects over time, similarly to function block 423.

Similarly, the result of the object detection checked by function block 419 or object recognition according to function block 413 is delivered to a function block 427. Similarly to function blocks 423, 425, a detected object or multiple detected objects according to function block 427 is/are tracked over time.

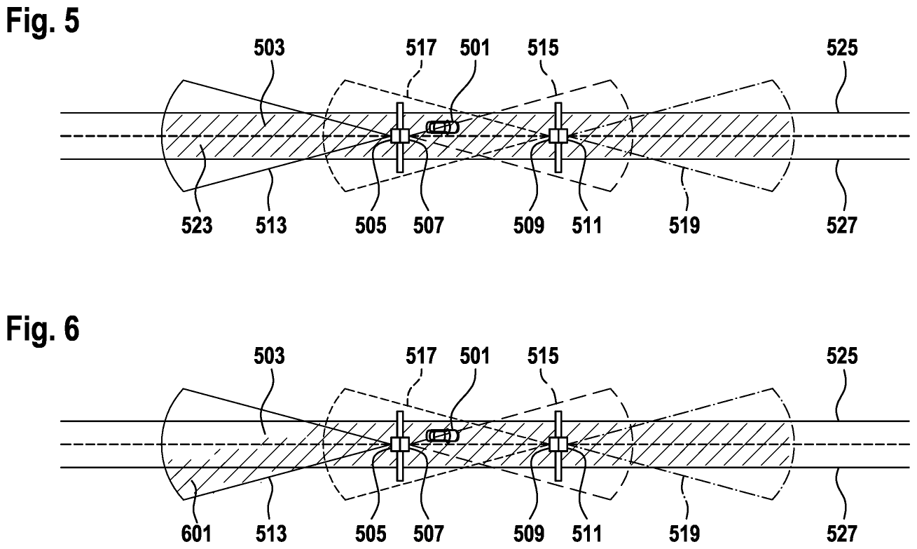

Thus, for example, respective trajectories of the detected objects are ascertained in function blocks 423, 425, 427. These trajectories are conveyed to a data fusion function 429. The data fusion function includes a function block 431, according to which the ascertained trajectories, which have been ascertained in each case based on video images, radar images and LIDAR images, are checked for consistency. This check includes, for example, a plausibility check of the trajectories. For the purpose of further illustration, reference is made here to FIGS. 5 through 8 and to the corresponding following explanations.

A result of this check is provided to state machine 421, which is able to decide based on the result which state the infrastructure system has.

The correspondingly checked trajectories are provided to a function block 433, according to which the individual trajectory data are fused.

The video images, radar images and LIDAR images are provided to a function block 435. From these input data, function block 435 generates for each sensor the information about the areas visible to the sensor. With this information, the occlusions resulting from static and dynamic obstacles are known to the system for each sensor. The generated pieces of information are the output of function block 435.

The output of function block 435 is provided firstly to function blocks 423, 425, 427 and secondly also to function block 433 for the purpose of carrying out the fusion of the trajectories.

Function block 433 outputs as output data within the context of the description a fused object detection result, which is checked for consistency in a function block 437.

The video images are further provided to a function block 439, according to which an open space recognition is carried out. The radar images are further provided to a function block 441, according to which an open space recognition is carried out based on the radar images. The LIDAR images are further provided to a function block 443, according to which an open space recognition is carried out based on the LIDAR images.

Corresponding open space recognition results of individual function blocks 439, 441, 443 are provided to a function block 445 of data fusion function 429, according to which the open space recognition results are fused to form a fused open space recognition result. Function block 445 outputs as output data within the context of the description the fused open space recognition result to function block 437, according to which the fused open space recognition result is checked.

The check steps according to function block 437 are, for example, the check steps described above and/or below.

A result of this check, i.e., a check result, is output to state machine 421, which is able to decide based thereupon, which state the infrastructure system has.

Accordingly, it may then be decided according to function block 447 what exactly is to be sent, for example, to motor vehicles, which drive in at least a semi-automated manner through the area or areas of the infrastructure.

If it should be established, for example, that according to function block 437 an inconsistency between the object detection result and the open space recognition result is present, the corresponding area in the open space recognition result is then marked as not open, i.e., as occupied and is sent to motor vehicles. In no event are inconsistent or invisible areas reported as open.

In one specific embodiment not shown, it is provided that, similarly to function block 431, a corresponding function block is provided upstream from function block 445 which, similarly to function block 431, checks the open space recognition results, for example, checks for consistency and/or for plausibility. A corresponding result may also be provided to state machine 421.

FIG. 5 shows a motor vehicle 501 driven in an at least semi-automated manner, which is driving on a road 503. Four infrastructure surroundings sensors are provided, a first infrastructure surroundings sensor 505, a second infrastructure surroundings sensor 507, a third infrastructure surroundings sensor 509 and a fourth infrastructure surroundings sensor 511. The first infrastructure surroundings sensor has a first detection area 513. Second infrastructure surroundings sensor 507 has a second detection area 515. Third infrastructure surroundings sensor 509 has a third detection area 517. Fourth infrastructure surroundings sensor 511 has a fourth detection area 519.

The four detection areas 513, 515, 517, 519 are each represented with the aid of differently dashed lines.

First infrastructure surroundings sensor 505 and third infrastructure surroundings sensor 509 detect (“see”) opposite the driving direction of motor vehicle 501, which extends from left to right relative to the paper plane.

Second infrastructure surroundings sensor 507 and fourth infrastructure surroundings sensor 511 detect (“see”) in the driving direction of motor vehicle 501.

At the point in time of its drive shown in FIG. 5, motor vehicle 501 is detected by both second infrastructure surroundings sensor 507 and third infrastructure surroundings sensor 509. During a drive thereof, motor vehicle 501 is dependent on the position of either one infrastructure surroundings sensor or of two infrastructure surroundings sensors in an overlapping area of the detection areas. In this way, a trajectory of motor vehicle 501 is ascertained over time based on the respective detections. If this is carried out over time for a plurality of motor vehicles, which is provided according to one specific embodiment, a heat map 523 may then be ascertained, for example, based on the trajectories thus ascertained. In the present case, heat map 523 has been ascertained for fully calibrated and functional infrastructure surroundings sensors.

As heat map 523 according to FIG. 5 clearly shows, the ascertained trajectories extend within boundary markings 525, 527 of road 503.

Thus, if the calibration is maintained and the infrastructure surroundings sensors function flawlessly, a correspondingly ascertained heat map should show that in the future as well the corresponding trajectories extend within the boundary markings.

In the case of a decalibration and/or an error in the infrastructure surroundings sensors, a different heat map is expected. This is represented, for example, in FIG. 6. There, a corresponding heat map is provided with reference numeral 601. As the representation according to FIG. 6 shows, heat map 601 no longer extends completely within roadway boundaries 525, 527, but partially outside thereof.

Thus, when a corresponding heat map is ascertained during the runtime of the infrastructure system, i.e., during the operation of the infrastructure system, then this is an indication that, for example, corresponding infrastructure surroundings sensors are decalibrated and/or an error has occurred.

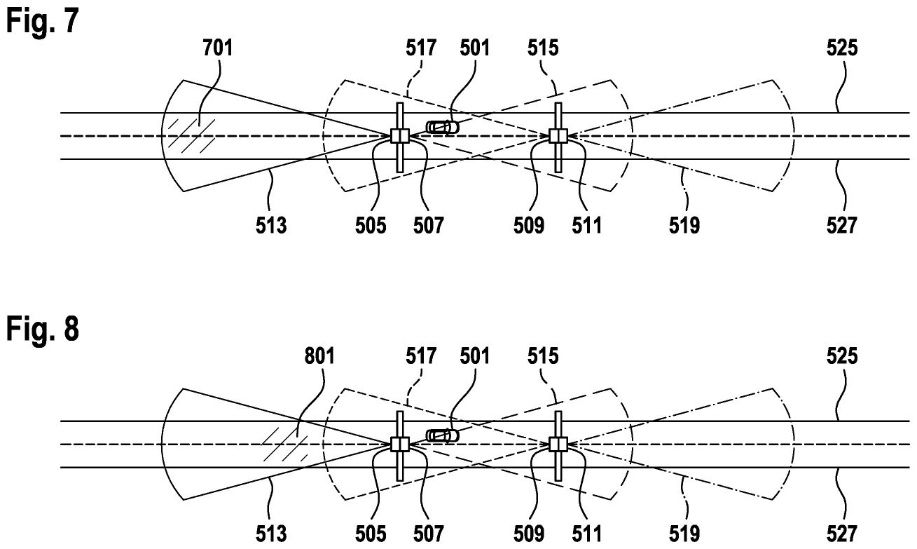

It may further be provided, for example, to ascertain for motor vehicle 501 a start position of an initial detection, for example, via first infrastructure surroundings sensor 505. When this is carried out for multiple motor vehicles over time, a heat map may also be ascertained, which is shown, for example, in FIG. 7. The heat map there is marked with reference numeral 701. Under optimal conditions, this heat map 701 should be oriented to the maximum detection range corresponding to first detection area 513. This is the case in FIG. 7.

If, however, the environmental conditions deteriorate, for example, due to rain or snow, the first infrastructure surroundings sensor 505 is no longer able to detect motor vehicles at its maximum detection range. Instead, an instantaneous detection range decreases, so that a start position of an initial detection is located within first detection area 513 and no longer corresponds to the maximum detection range. If this is ascertained for multiple motor vehicles over time, a corresponding heat map may again be ascertained, which is represented in FIG. 8 by a heat map with reference numeral 801.

As FIG. 8 clearly shows, the corresponding start positions according to heat map 801 are located within first detection area 513.

In summary, the concept described herein is based, in particular, on the monitoring of a data fusion function with the aid of a data fusion monitoring function and, for example, conveying a result of the monitoring to a state machine. The data fusion monitoring function aids in identifying inconsistencies in various phases of the perception pipeline. On the basis of the monitoring results, the state machine decides, for example, whether degradation functions are required to be activated. The instantaneous status of the degradation is communicated, for example, at the system output.

The data fusion monitoring function may, for example, include one or multiple of the following three possibilities:

Possibility 1: based on the comparison of pieces of fused open space information (fused open space recognition result) with global fused objects (fused object detection result).

Pieces of open space information are complementary and they and global fused objects are mutually exclusive. This is the basis on which inconsistencies between two information sources are able to be identified. Example: in a particular area, the global fusion reports an object with an 80% probability of existence. If the open space fusion function reports an open space in the same area with a high degree of certainty, this is a clear inconsistency, which is able to be recognized.

In the case of infrastructure perception systems, dynamic occlusions may occur due to different mounting points and view angles of the infrastructure surroundings sensors. Such occlusions are taken into account, for example, in this monitoring function by using the pieces of information about the dynamic visibility grid calculated for each sensor.

Moreover, the ascertained discrepancies may, for example, be used for adapting the pieces of open space information in order to avoid erroneous interpretations within the at least semi-automated motor vehicle. In the above example, in which an object has been reported with a high degree of probability, the uncertainty of the open space in this area may, for example, be heightened in order to ensure the overall consistency of the surroundings model provided by the system.

Possibility 2: based on the comparison between multiple infrastructure surroundings sensors.

Using the 2-out-of-3 principle, it is possible to use the probability of the presence of each individual sensor object together with the probability of the presence of the global fusion object in order to identify false-positive and false-negative cases.

Possibility 3: based on the trajectories of the recognized sensor objects.

Based on the fact that the perception system (arrangement of the multiple infrastructure surroundings sensors) is static, particular trajectories of the objects may be assumed, which pass through the field of view of the perception system. An accumulation of improbable start points and end points or paths of the trajectories may be recognized. If the object data provide improbable trajectories in any stage of the perception pipeline, the part of the perception pipeline providing these improbable trajectories is reported to the state machine.

Thus, this yields the technical advantage of identifying inconsistencies in order to determine a suitable system response. For example: if a system degradation is necessary.

This may ensure an improvement in the safety and performance of the system.

The perception pipeline obtains its input data from the infrastructure surroundings sensors, for example, using different measuring principles, in order to minimize the risk of errors having a common cause. From this point, two parallel processing paths, for example, are carried out:

### 1. Object-Based Perception

a) Based on the received sensor data, sensor-specific object recognition algorithms and sensor-specific tracking algorithms generate object data (local tracks) of tracked objects for each infrastructure surroundings sensor. At this stage already, monitoring functions are possible in order to validate the local tracks.

b) Function block 431 checks the content of the local tracks, for example, based on their trajectories (possibility 3, described above).

c) The object fusion according to function block 433 combines, for example: local tracks, knowledge about where each infrastructure surroundings sensor is able to recognize objects (from the dynamic visibility grid), to fused object tracks (global tracks).

d) Function block 437 uses, for example, the global tracks (from function block 433), the pieces of information about the contributing infrastructure surroundings sensors (from function block 433), the knowledge about where each infrastructure surroundings sensor is able to recognize objects (from the dynamic visibility grid) in order to recognize false-positive or false-negative cases.

### 2. Open Space-Based Perception

a) The sensor-specific open space detectors generate pieces of open space information (local open space) on the basis of the received surroundings sensor data.

b) The open space fusion combines the local open spaces to form a global open space.

In addition to the recognition of false-positive and false negative, function block 437 compares, for example, also the global tracks and the global open space in order to find inconsistencies between them (possibilities 1 and 2 described above).

Each monitoring block along the perception pipeline reports a corresponding monitoring result to state machine 421, which controls, for example, an output of the infrastructure system by the former deciding on a suitable system response.

The monitoring function, which is based on the trajectories of the sensor objects, is explained in greater detail below.

Decalibrated infrastructure surroundings sensors may result in false sensor-object trajectories (in particular, in areas, which are covered by only a single infrastructure surroundings sensor). This decalibration of a single sensor is to be monitored.

It is expected that the trajectories of the motor vehicles follow essentially the boundaries of the traffic lanes. If the traffic lanes on the map and the average trajectories do not coincide, a decalibrated sensor could be the cause thereof.

Moreover, the performance of the infrastructure surroundings sensors is not always identical. Environmental influences (poor weather, glare, dim light) or a poor calibration may affect the detection performance of the infrastructure surroundings sensors. This performance deterioration is monitored, for example.

Under perfect conditions, it is expected that the trajectories of the motor vehicles are created at similar distances/positions, i.e., when they enter into the field of view of the sensor. The same applies, for example, to the termination of the trajectories of motor vehicles, when they leave the field of view of the infrastructure surroundings sensor. The area of the trajectory creation and/or trajectory termination may change in comparison to normal behavior due to environmental influences (for example, weather or time of day) and/or decalibration.

Heat maps may be used in order to store past areas of the object creation and object termination. Heat map 701 shows the nominal behavior during object creation. The objects are generated mainly at the edge of the field of view. According to heat map 801, the object recognition is heavily influenced by the surroundings and thus the object recognition area is also reduced. The object tracks are generated later at a different position than in the setpoint behavior, which is indicated by the shift according to heat map 601. A similar heat map may be created and monitored, for example, for the termination of the track.

1-11. (canceled)

12. A method for monitoring a data fusion function of an infrastructure system for an infrastructure-supported assistance of motor vehicles during an at least semi-automated driving task within an infrastructure, the infrastructure system including multiple infrastructure surroundings sensors configured to detect an area of the infrastructure, the method comprising the following steps:
receiving multiple input data sets intended for the data fusion function, each of which includes surroundings data based on a respective detection of the area, which represent the detected area;
receiving output data based on a data fusion of the input data sets, output by the data fusion function;
checking the input data sets and/or the output data for consistency; and
outputting a check result of the check.

13. The method as recited in claim 12, wherein some of the input data sets include in each case an open space recognition result, which indicates a result of an open space recognition of the area, the output data including a fused open space recognition result of the respective open space recognition results.

14. The method as recited in claim 13, wherein some of the input data sets include in each case an object detection result, which indicates a result of an object detection of the area, the output data including a fused object detection result of the respective object detection results.

15. The method as recited in claim 14, wherein the check includes a comparison of the fused open space recognition result with the fused object detection result in order to detect inconsistencies.

16. The method as recited in claim 14, wherein an object detection majority result is ascertained, which corresponds to the object detection result of a majority of identical object detection results, the check including a comparison of the fused object detection results with the object detection majority result in order to detect inconsistencies.

17. The method as recited in claim 12, wherein one of the input data sets includes trajectory data, which represent a trajectory of an object located within the area, the check including a check of the trajectory for plausibility in order to detect inconsistencies.

18. The method as recited in claim 12, wherein one of the input data sets includes position data, which represent an initial position of an object located within the area at a point in time of an initial detection by a corresponding one of the infrastructure surroundings sensors, the check including a comparison of the initial position with a maximum detection range of the corresponding infrastructure surroundings sensor in order to detect inconsistencies between the initial position and the maximum detection range.

19. The method as recited in claim 12, wherein one of the input data sets includes position data, which represent an end position of an object located within the area at a point in time of a final detection by the corresponding infrastructure surroundings sensor, the check including a comparison of the end position with a maximum detection range of a corresponding one of the infrastructure surroundings sensors in order to detect inconsistencies between the end position and the maximum detection range.

20. A device configured to monitor a data fusion function of an infrastructure system for an infrastructure-supported assistance of motor vehicles during an at least semi-automated driving task within an infrastructure, the infrastructure system including multiple infrastructure surroundings sensors configured to detect an area of the infrastructure, the device configured to:
receive multiple input data sets intended for the data fusion function, each of which includes surroundings data based on a respective detection of the area, which represent the detected area;
receive output data based on a data fusion of the input data sets, output by the data fusion function;
check the input data sets and/or the output data for consistency; and
output a check result of the check.

21. A non-transitory machine-readable memory medium on which is stored a computer program for monitoring a data fusion function of an infrastructure system for an infrastructure-supported assistance of motor vehicles during an at least semi-automated driving task within an infrastructure, the infrastructure system including multiple infrastructure surroundings sensors configured to detect an area of the infrastructure, the computer program, when executed by a computer, causing the computer to perform the following steps:
receiving multiple input data sets intended for the data fusion function, each of which includes surroundings data based on a respective detection of the area, which represent the detected area;
receiving output data based on a data fusion of the input data sets, output by the data fusion function;
checking the input data sets and/or the output data for consistency; and
outputting a check result of the check.
